(19) United States
(12) Patent Application Publication
(10) Pub. No.: US 2007/0071135 A1
(43) Pub. Date: Mar. 29, 2007

(54) Method and device for increasing the capacity of non-spread transmission systems

(76) Inventor: Marc Chenu-Tournier, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/580,203

(22) PCT Filed: Nov. 2, 2004
(86) PCT No.: PCT/EP04/53140

§ 371 Date: May 23, 2006

(30) Foreign Application Priority Data
Nov. 28, 2003 (FR) 0314014

(51) Int. Cl. H04L 27/00

(52) U.S. Cl. 375/324

(57) ABSTRACT

A method for increasing the capacity of signal transmission systems comprising N_{T} users, a single-piece receiver receiving the mixture of signals originating from the N_{T} users including at least the following steps:
determining a qualitative information Info(Qs) of the symbols estimated for each of the N_{T} users, transmitting this information Info(Qs) to a processing block receiving an a priori information and designed to generate a quality information Info(Qbs) on the bits forming the symbols, transmitting the Info(Qbs) to a decoding step to obtain a qualitative information on the encoded bits and Info(Qbu) on the useful bits.

The invention relates in particular to a method for increasing the capacity of transmission systems by multiplying the number of simultaneous senders in one and the same frequency band and enabling the users to be separated in particular through the use of iterative steps.

Known from the prior art are methods enabling simultaneous transmission from different users. These normally rely on the use of spreading codes, such as CDMA (Code Division Multiple Access), MCCDMA (Multicarrier Code-Division-Multiple-Access) and/or on the use of multiple-antenna receivers.

The method according to the invention relies in particular on a novel approach which exploits the independence of the binary streams (signals originating from the different senders), channel encoding and the difference of the majority of the propagation channels.

The invention relates to a method for increasing the capacity of signal transmission systems comprising N_{T} users, a single-piece receiver receiving the mixture of signals originating from the N_{T} users. It is characterized in that it includes at least the following steps:
a) determining a qualitative information Info(Qs) of the symbols estimated for each of the N_{T} users,
b) transmitting this information Info(Qs) to a processing block receiving an a priori information and designed to generate a quality information, Info(Qbs), on the bits forming the symbols,
c) transmitting the Info(Qbs) to a decoding step to obtain a qualitative information Info(Qbs) on the encoded bits and Info(Qbu) on the useful bits.

The method according to the invention allows, notably to:
increase the bit rate of the transmission systems that use existing standards for the user stations by modifying only the access point,
simply separate the different binary streams by exchanging information between the demodulation block and the decoding block,
increase the capacity of the transmission systems by multiplying the number of senders without using multiple-antenna receivers and without using spectrum spreading techniques, in the context of normal operation.

Other advantages and characteristics of the invention will become more apparent from reading the description that follows of a detailed example, given purely for illustration and by no means limiting, with appended figures in which:

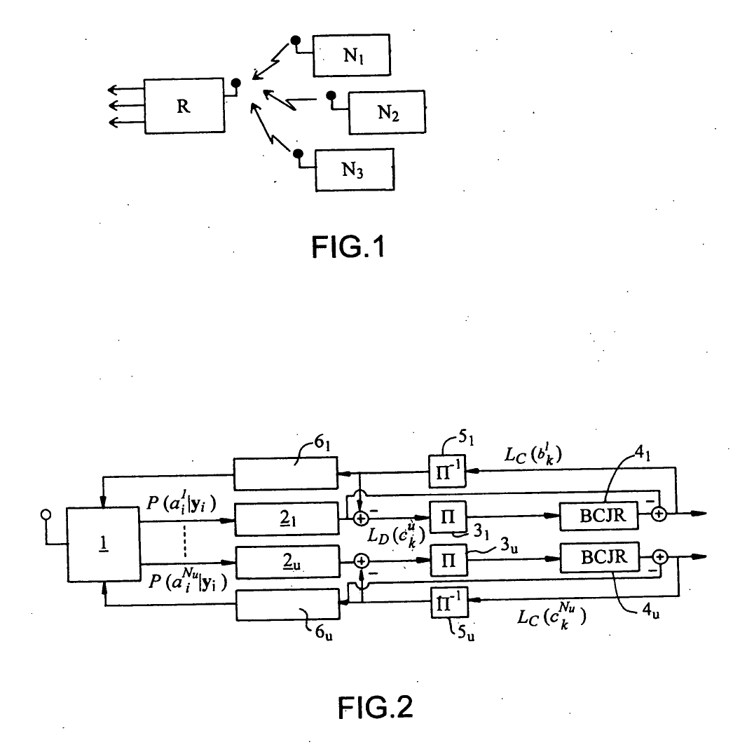

FIG. 1 shows a global diagram of the method according to the invention, and

FIG. 2 shows a detailed generic diagram of the steps of the method according to the invention.

FIG. 1 diagrammatically represents the various steps of the method according to the invention used in a communication or transmission system comprising a number of users or senders N_{T}, and a receiver comprising, for example, a monosensor R. The various senders transmit the symbols simultaneously in the same frequency band, for example. Since the communications are normally disturbed by a propagation channel, a channel encoding is conventionally used. The method uses, for example, this encoding to perform the demodulation.

FIG. 2 shows the generic diagram of an exemplary monosensor receiver.

It comprises a module 1 for receiving the mixture of the signals sent by the N_{T} users or senders, separating the different users and supplying a qualitative information, Info(Qs), of the symbols estimated for each of the users N_{T} (for example, a probability of having received such a symbol). The module 1 can be a detector in the maximum a posteriori (MAP) sense which provides a probability of the symbols sent for the different senders N_{T} relying on an a priori information. The information on the estimated symbols Info(Qs) is then transmitted to a processing block which will deduce from this a quality information on the bits that form the symbols Info(Qbs). This information Info(Qbs) is then transmitted to the decoding block 4i (a de-interleaving procedure can be applied beforehand) which, in turn, will produce a qualitative information Info(Qbs) on the encoded bits and Info(Qbu) on the useful bits.

The information on the encoded bits Info(Qbs) can be reused in order to re-estimate an information on the symbols as described previously. The information on the useful bits is deduced from the information on the encoded bits, for example, by the decoding procedure.

A prior processing of the informations transmitted to the different blocks may prove necessary for the method to operate correctly. In the example described below, the information previously used to estimate a new qualitative information on a bit, is subtracted in order to supply only a real new information to the block receiving it.

These steps are repeated, either a fixed number of times, or until a criterion is satisfied (for example, the qualitative informations cease to change).

The way the method operates is described below as an example for the user N₁.

The information on the probability of symbols sent P(a¹_{Nu}|yi), Info(Qs), is transmitted to a device 2₁ (or demapping) having the main function of providing an information on the probability of the bits sent L_{D}(cₖ¹) by the user N₁, Info(Qbs). This information is, for example, sent in a de-interleaver 3₁, then to a BCJR type algorithm (encoding block 4i) in order to obtain the probability of the encoded bits L_{c}(cₖ¹) (qualitative information on the encoded bits, Info(Qbs), and the useful bits, Info(Qbu)). This latter information (L_{c}(cₖ¹)) is subtracted from the first information L_{D}(cₖ¹) of probability on the bits (quality information on the bits forming the symbols Info(Qs)) before going on to the de-interleaver. It is also sent to an interleaver 5₁, then to a device 6₁ having a mapping function, before being reinjected into the device 1 which uses this information Info(Qs) in the step for obtaining the probability of the symbols sent.

The mapping and demapping devices, the interleavers and the de-interleavers are devices known to those skilled in the art which are not detailed in the present description.

In order to illustrate the method according to the invention, the example that follows is given in the case of frequency-synchronized OFDM (orthogonal frequency division multiplexing) senders. For this so-called multi-carrier or parallel waveform, the different symbols are transmitted simultaneously on orthogonal subcarriers.

In this exemplary embodiment, the different senders use a convolutional code as in the Hiperlan/2 or IEEE802.11a standard.

The receiver conventionally performs a discrete Fourier transform (DFT) on a predetermined timeslot to estimate the transmitted symbols.

In the case of multiple sendings that are frequency-synchronized and sufficiently synchronized in time to avoid the inter-symbol interference, the signal received by the receiver after the Fourier transform is given by:
y=F₂I _{P̅C̅}HI_{PC}F₁a+b (1)
in which
y is the received signal represented by a vector (N_{SP})×1 with N_{SP} being the number of subcarriers,
a is the dimension vector (N_{T}×N_{SC})×1 containing the symbols transmitted by the N_{T} senders. The N_{T} first elements are the symbols transmitted on the first subcarrier,
F₁=\tilde{F}₁ [symbol] I_{N}_{_{T}} is the matrix performing the DFT on sending with I_{N}_{_{T}} being the dimension identity matrix N_{T} and the operator [symbol] being the Kronecker product,
I_{PC}=Ĩ_{PC} [symbol] I_{N}_{_{T}} is the dimension matrix N_{T}(N_{N}_{_{CP}}+N_{DFT})×N_{T}N_{N}_{_{DFT}} which performs the insertion of the cyclic prefix (specific to OFDM),
H is the matrix of the samples representing the propagation channel, of dimension (N_{T}(N_{N}_{_{CP}}+N_{DFT})+N_{H})×N_{T}(N_{N}_{_{DFT}}+N_{CP}) with N_{H} being the maximum length of the propagation channels,
I _{C̅P̅}=Ĩ _{C̅P̅} [symbol] I_{N}_{_{T}} is the matrix that performs the synchronization and removes the cyclic prefix,
F₂ is the matrix that performs the DFT on the receiver,
b is the dimension vector N_{SP}×1 containing the samples of the noise considered in this example as temporally white noise.

The matrix K defined below is a rotating block matrix and as such can be expressed as:
K=F₂^{H}GF₁ (2)
in which G is a diagonal block matrix and F₁ and F₂ are DFT matrices.

Since I _{P̅C̅}HI_{PC} is a circulating block, the received signal can be expressed as:
y=Ga+b (3)
in which G is a diagonal block matrix with blocks of size 1×N_{T}.

Therefore, for the subcarrier i, the vectorial observation yᵢ can be expressed as:
yᵢ=Gᵢaᵢ+bᵢ (4)
in which Gᵢ contains the elements of the frequency response of the channel.

In this case, since we are using only one receiver, G is a vector of size 1×N_{T}.

Thus the observation yᵢ is scalar and is expressed:

$${y}_{i} = {\sum }_{i = 1}^{{N}_{T}} {h}_{i} {a}_{i} + {b}_{i} \qquad ( 5 )$$

In this case, the detector in the MAP sense supplies the following probabilities:
(qualitative information of the estimated symbols—probability of the symbols sent for the different senders)

$$p ( {a}_{i}^{k} = a \text{\textbar} {y}_{i} , {G}_{i} , {σ}^{2} ) = \frac{{\sum }_{{a}_{t} ∈ {A}_{a}^{k}} p ( {y}_{i} \text{\textbar} {a}_{t} , {G}_{i} , {σ}^{2} ) p ( {a}_{t} )}{{\sum }_{{a}_{t} ∈ A} p ( {y}_{i} \text{\textbar} {a}_{t} , {G}_{i} , {σ}^{2} ) p ( {a}_{t} )} \qquad ( 6 )$$

in which σ² is the variance of the noise and Aₐ^{k} is defined by:
Aₐ^{k}={a|a^{k}=a} (7)

Aₐ^{k} contains the symbol vectors a which have the symbol a in the position k.

These probabilities are then used to calculate the probability of the bits forming the symbols:

$$L ( c ) = log \frac{{\sum }_{a ∈ {A}^{+}} p ( a \text{\textbar} {y}_{i} , {G}_{i} , {σ}^{2} )}{{\sum }_{a ∈ {A}^{-}} p ( a \text{\textbar} {y}_{i} , {G}_{i} , {σ}^{2} )} \qquad ( 8 )$$

in which A⁺ is the set of symbols in which the bit c is 1 and A⁻is the set of symbols in which the bit c is 0.
These quantities are then used to calculate:
L_{D}(C)=L(C)-L_{c}(c) (9)
which is supplied to the decoding block. In the figure, the equation (9) is represented by the indices L_{D}(cₖⁱ)=L(c)-L_{c}(cₖⁱ).

The term L_{c}(C) (L_{c}(cₖⁱ) in FIG. 2) corresponds to the a priori information derived from the preceding decoding. On the first iteration, L_{c}(c)=0. These values L_{D}(c) (L_{D}(cₖⁱ) in FIG. 2) are the inputs of the flexible decoder which, in the example, is a BCJR type algorithm, described, for example, in the document by L. Bahl, J. Cocke, F. Jelinek, and J. Raviv, entitled “Optimal decoding of linear codes for minimizing symbol error rate”, IEEE Trans. Inform. Theory, pp. 284-287, March 1974. This block is not described any more in detail.

This decoder supplies both the probability of the useful bits (before encoding) and the probability of the encoded bits that form the symbols.

The method is used, for example, for BPSK (Bit Phase Shift Keying) or QPSK (Quadrature Phase Shift Keying) modulation schemes.

1. A method for increasing the capacity of signal transmission systems comprising N_{T} users, a single-piece receiver receiving the mixture of signals originating from the N_{T} users, comprising the following steps:
a) determining a qualitative information of the symbols estimated for each of the N_{T} users,
b) transmitting this information to a processing block receiving an a priori information and designed to generate a quality information, on the bits forming the symbols, and
c) transmitting the to a decoding step to obtain a qualitative information on the encoded bits and on the useful bits.

2. The method as claimed in claim 1, wherein step a) is performed using an MAP (Maximum a Posteriori) detector.

3. The method as claimed in claim 1, wherein the steps a) to c) are repeated until the qualitative information is fairly constant.

4. The use of the method as claimed in claim 1, for transmitters using one of the following modulation schemes: BPSK, QPSK, OFDM.

5. The use of the method as claimed in claim 2, for transmitters using one of the following modulation schemes: BPSK, QPSK, OFDM.

6. The use of the method as claimed in claim 3, for transmitters using one of the following modulation schemes: BPSK, QPSK, OFDM.
